(19) United States
(12) Patent Application Publication
(10) Pub. No.: US 2026/0237202 A1
(43) Pub. Date: Aug. 13, 2026

(54) METHOD AND APPARATUS FOR DETERMINING SEWAGE TREATMENT MODE, COMPUTER DEVICE AND STORAGE MEDIUM

(71) Applicants: CTG LOGISTICS MANAGEMENT (BEIJING) CO., LTD., Beijing (CN); CHINA THREE GORGES CORPORATION, Wuhan, Hubei (CN)

(72) Inventors: Yasong CHEN, Beijing (CN); Zilin WANG, Beijing (CN); Yufeng CHEN, Beijing (CN); Mengmeng LIU, Beijing (CN); Fangyuan JING, Beijing (CN)

(73) Assignees: CTG LOGISTICS MANAGEMENT (BEIJING) CO., LTD., Beijing (CN); CHINA THREE GORGES CORPORATION, Wuhan, Hubei (CN)

(21) Appl. No.: 19/151,039

(22) PCT Filed: Sep. 14, 2024
(86) PCT No.: PCT/CN2024/119070

§ 371 Date: Jul. 25, 2025

(30) Foreign Application Priority Data
Nov. 7, 2023 (CN) 202311468430.1

(51) Int. Cl. G06V 20/10; G06V 10/762

(52) U.S. Cl. CPC G06V 20/176; G06V 10/762

(57) ABSTRACT

A method and apparatus for determining a sewage treatment mode, a computer device, and a storage medium. By processing an image dataset and a site dataset of an area to be determined, a house geographical location information matrix corresponding to the area to be determined can be determined. Further, an iterative cluster analysis is performed on houses in the area to be determined through a house geographical location information matrix, to determine a target total investment value of the area to be determined. Further, the sewage treatment mode of the area can be determined according to the target total investment value, with no need of conducting a large number of on-site surveys and investigations based on subjective experience. Therefore, a final sewage treatment mode is determined by combining a preset clustering method based on image processing and analysis.

The present application claims the priority of a Chinese patent application filed with the China Patent Office on Nov. 7, 2023, with an application number of 202311468430.1 and entitled “Method and Apparatus for Determining Sewage Treatment Mode, Computer Device, and Storage Medium”, the contents of which are incorporated herein by reference in its entirety.

### TECHNICAL FIELD

The present application relates to the technical field of sewage treatment, in particular to a method and apparatus for determining a sewage treatment mode, a computer device, and a storage medium.

### BACKGROUND

Rural sewage collection and treatment modes generally include decentralized, centralized, and pipe-connected treatment. However, both decentralized and centralized are relative concepts, and there is no clear boundary for the number of connected households. Therefore, in rural sewage treatment modes, methods such as “large-scale centralization”, “small-scale centralization”, and “decentralized household” often appear. In essence, these modes represent the degree of decentralization and centralization, embodied in the number of sewage treatment sites and the number of households whose sewage is collected by each site. Therefore, the degree of decentralization and centralization largely determines the length of a collection pipeline and the number of sites, and particularly affects the investment in rural sewage treatment. The unit construction cost per household is an important indicator for measuring rural sewage treatment modes.

In actual engineering, the degree of decentralization and centralization in the rural sewage collection and treatment mode is generally subjectively judged by designers according to the natural characteristics of villages and the layout of houses. The designers determine the sewage collection scope (number of households), the location of treatment sites, etc., thereby determining the degree of decentralization and centralization. Nevertheless, this subjective approach based on empirical judgment will lead to different standards and different results for different villages by different personnel at different stages. This method not only lacks objective and scientific judgment basis, resulting in unreasonable layout of sites, unscientific household connection scope, and relatively high per-household investment costs in many engineering projects, but also requires extensive on-site research which is time-consuming and labor-intensive.

### SUMMARY OF THE INVENTION

In view of this, the present application provides a method and apparatus for determining a sewage treatment mode, a computer device, and a storage medium, to solve the problems that the existing method of judging the rural sewage collection and treatment mode based on experience not only lacks objective and scientific judgment basis, resulting in unreasonable layout of sites, unscientific household connection scope, and relatively high per-household investment costs in many engineering projects, but also requires extensive on-site research which is time-consuming and labor-intensive.

In a first aspect, the present application provides a method for determining a sewage treatment mode, and the method includes:
acquiring a preset site dataset, an image dataset of an area to be determined, and a raster file;
obtaining a house geographical location information matrix corresponding to the area to be determined through preset image processing and analysis methods based on the preset site dataset, the image dataset, and the raster file;
iteratively performing cluster analysis on houses in the area to be determined using a preset clustering method based on the house geographical location information matrix, until a target total investment value of the area to be determined that meets preset conditions is obtained; and
determining the sewage treatment mode of the area to be determined based on the target total investment value.

In an optional embodiment, the step of obtaining a house geographical location information matrix corresponding to the area to be determined through preset image processing and analysis methods based on the preset site dataset, the image dataset, and the raster file includes:
acquiring a preset processing tool; importing the raster file and the preset site dataset into the preset processing tool to obtain a target processing tool; and performing geographical data processing and analysis on the image dataset using the target processing tool to obtain the house geographical location information matrix corresponding to the area to be determined.

In the present application, a preset processing tool with imported raster files and preset site datasets is utilized to perform geographical data processing and analysis on the image dataset, thereby improving the speed of image data processing and providing a basis for subsequently reducing the time for determining the sewage treatment mode.

In an optional embodiment, the step of iteratively performing cluster analysis on houses in the area to be determined using a preset clustering method based on the house geographical location information matrix until a target total investment value of the area to be determined that meets preset conditions is obtained includes:
acquiring a preset prior knowledge set; determining the number of initial sites based on the preset prior knowledge set; and iteratively performing cluster analysis on the houses in the area to be determined using the preset clustering method based on the number of the initial sites and the house geographical location information matrix, until the target total investment value of the area to be determined is obtained.

In the present application, based on the house geographical location information matrix, an iterative cluster analysis is performed on the houses in the area to be determined in combination with a clustering method, thereby making the target total investment value of the area to be determined more objective and providing data support for the subsequent objective determination of the sewage treatment mode.

In an optional embodiment, the step of iteratively performing cluster analysis on the houses in the area to be determined using the preset clustering method based on the number of the initial sites and the house geographical location information matrix until the target total investment value of the area to be determined is obtained includes:
performing cluster analysis on the houses in the area to be determined using a preset clustering method based on the number of the initial sites, to obtain the number of first target sites and a site geographical location information matrix;
processing through a preset analysis method and a preset calculation method based on the house geographical location information matrix and the site geographical location information matrix, to obtain a total investment value of the area to be determined under the number of the first target sites;
judging whether the number of the first target sites meets the preset conditions; increasing the number of the first target sites when the number of the first target sites does not meet the preset conditions, and based on the increased total investment value of the corresponding area to be determined, repeating the step of performing cluster analysis on the houses in the area to be determined using a preset clustering method to obtain the number of first target sites and a site geographical location information matrix and repeating the step of processing through a preset analysis method and a preset calculation method based on the house geographical location information matrix and the site geographical location information matrix to obtain the total investment value of the area to be determined under the number of the first target sites, until the increased number of the first target sites meets the preset conditions, to obtain the total investment value of the area to be determined corresponding to each increased number of the first target sites; and
determining the target total investment value of the area to be determined based on each of the total investment values.

In the present application, through iterative cluster analysis, the final number of sites can be objectively determined. Further, based on this number of sites, the target total investment value of the area to be determined is determined, thereby making the target total investment value more objective and providing data support for the subsequent objective determination of the sewage treatment mode.

In an optional embodiment, the method further includes:
when the number of the first target sites meets the preset conditions, taking the total investment value of the area to be determined under the number of the first target sites as the target total investment value of the area to be determined.

In an optional embodiment, the step of performing cluster analysis on the houses in the area to be determined using a preset clustering method based on the number of the initial sites to obtain the number of first target sites and an initial site geographical location information matrix includes:
performing cluster analysis on the houses in the area to be determined using a preset clustering method based on the number of the initial sites, to obtain the number of the first target sites that meet the conditions; clustering the area to be determined based on the number of the first target sites, to obtain a plurality of initial sub-areas to be determined corresponding to the area to be determined; and determining the initial site geographical location information matrix corresponding to the area to be determined through a preset screening processing method based on the plurality of initial sub-areas to be determined.

In the present application, the number of first target sites that meet the conditions can be determined through cluster analysis. Further, the area to be determined is processed according to the number of the first target sites, and an initial site geographical location information matrix in the area to be determined can be obtained, providing data support for the objective determination of the subsequent sewage treatment mode.

In an optional embodiment, the step of processing through a preset analysis method and a preset calculation method based on the house geographical location information matrix and the site geographical location information matrix to obtain the total investment value of the area to be determined under the number of the first target sites includes:
obtaining a pipeline length corresponding to the number of the first target sites through the Euclidean distance calculation formula based on the house geographical location information matrix and the site geographical location information matrix; and processing through a preset analysis method and a preset calculation method based on the site geographical location information matrix and the pipeline length, to obtain the total investment value of the area to be determined under the number of the first target sites.

In an optional embodiment, the step of determining the sewage treatment mode of the area to be determined based on the target total investment value includes:
acquiring the number of second target sites corresponding to the target total investment value and a target information matrix of the site target geographical location; and determining the sewage treatment mode of the area to be determined based on the target total investment value, the number of the second target sites, and a target information matrix of the site target geographical location.

In the present application, the area to be determined is processed according to the determined final number of second target sites, and the finally determined target information matrix of the site target geographical location in the area to be determined can be obtained. Further, in combination with the target total investment value, the sewage treatment mode of the area to be determined can be objectively determined, thereby reducing the time for determining the sewage treatment mode and improving the accuracy of determining the sewage treatment mode.

In a second aspect, the present application provides an apparatus for determining a sewage treatment mode, including:
an acquisition module configured to acquire a preset site dataset, an image dataset of the area to be determined, and a raster file; a processing module configured to obtain a house geographical location information matrix corresponding to the area to be determined through preset image processing and analysis methods based on the preset site dataset, the image dataset, and the raster file; an analysis module configured to iteratively perform cluster analysis on the houses in the area to be determined using a preset clustering method based on the house geographical location information matrix, until a target total investment value of the area to be determined that meets preset conditions is obtained; and a determination module configured to determine the sewage treatment mode of the area to be determined based on the target total investment value.

In an optional embodiment, the processing module includes:
a first acquisition submodule configured to acquire a preset processing tool; an import submodule configured to import the raster file and the preset site dataset into the preset processing tool to obtain a target processing tool; and a processing submodule configured to perform geographical data processing and analysis on the image dataset by using the target processing tool, to obtain the house geographical location information matrix corresponding to the area to be determined.

In an optional embodiment, the analysis module includes:
a second acquisition submodule configured to acquire a preset prior knowledge set; a first determination submodule configured to determine the number of initial sites based on the preset prior knowledge set; and an analysis submodule configured to iteratively perform cluster analysis on the houses in the area to be determined by using the preset clustering method based on the number of the initial sites and the house geographical location information matrix until the target total investment value of the area to be determined is obtained.

In an optional embodiment, the analysis submodule includes:
an analysis unit configured to perform cluster analysis on the houses in the area to be determined by using a preset clustering method based on the number of the initial sites, to obtain the number of first target sites and the site geographical location information matrix;
a processing unit configured to process through a preset analysis method and a preset calculation method based on the house geographical location information matrix and the site geographical location information matrix to obtain the total investment value of the area to be determined under the number of the first target sites;
a judgment unit configured to judge whether the number of the first target sites meets the preset conditions;
a repetition unit configured to increase the number of the first target sites when the number of the first target sites does not meet the preset conditions, and based on the increased total investment value of the corresponding area to be determined, repeat the step of performing cluster analysis on the houses in the area to be determined using the preset clustering method to obtain the number of the first target sites and the site geographical location information matrix and repeat the step of processing through a preset analysis method and a preset calculation method based on the house geographical location information matrix and the site geographical location information matrix to obtain the total investment value of the area to be determined under the number of the first target sites, until the increased number of the first target sites meets the preset conditions, to obtain the total investment value of the area to be determined corresponding to each increased number of the first target sites; and
a first determination unit configured to determine the target total investment value of the area to be determined based on each of the total investment values.

In an optional embodiment, the analysis submodule further includes:
a second determination unit configured to: when the number of the first target sites meets the preset conditions, take the total investment value of the area to be determined under the number of the first target sites as the target total investment value of the area to be determined.

In a third aspect, the present application provides a computer device, including: a memory and a processor, wherein the memory and the processor are communicatively connected with each other, computer instructions are stored in the memory, and the processor is configured to execute the method for determining the sewage treatment mode according to the first aspect or any corresponding implementation manner described above by executing the computer instructions.

In a fourth aspect, the present application provides a computer-readable storage medium, wherein the computer-readable storage medium has computer instructions stored therein, and the computer instructions are configured to enable a computer to execute the method for determining the sewage treatment mode according to the first aspect or any corresponding implementation manner described above.

### BRIEF DESCRIPTION OF THE DRAWINGS

FIG. 1 is a flow diagram of a method for determining a sewage treatment mode according to an embodiment of the present application;

FIG. 2 is a flow diagram of another method for determining a sewage treatment mode according to an embodiment of the present application;

FIG. 3 is a flow diagram of still another method for determining a sewage treatment mode according to an embodiment of the present application;

FIG. 4 is a flow diagram of an optimized determination method for the degree of decentralization and concentration in the rural sewage treatment mode according to an embodiment of the present application;

FIG. 5 is an initial point map of a house with geographical location information according to an embodiment of the present application;

FIG. 6 is an initial point map of a house without geographical location information according to an embodiment of the present application;

FIG. 7 is a structural block diagram of an apparatus for determining a sewage treatment mode according to an embodiment of the present application;

FIG. 8 is a schematic diagram of a hardware structure of a computer device according to an embodiment of the present application.

### DETAILED DESCRIPTION

To make the objectives, technical solutions, and advantages of the embodiments of the present application clearer, the technical solutions in the embodiments of the present application will be described clearly and completely below in conjunction with the accompanying drawings in the embodiments of the present application. Obviously, the described embodiments are part but not all of the embodiments of the present application. Based on the embodiments in the present application, all the other embodiments obtained by those skilled in the art without any creative effort shall all fall within the protection scope of the present application.

There is no unified standard for the degree of decentralization and centralization of rural sewage. It is necessary to adapt to local conditions in combination with village characteristics. Currently, the design is mainly based on subjective experience, lacking a method for discrimination and optimal determination based on objective criteria. Further, a large number of on-site surveys and investigations need to be performed based on subjective experience, thereby being time-consuming and labor-intensive and resulting in low work efficiency. Moreover, the current design and determination methods generally lack technical and economic rationality, often leading to an unreasonable treatment mode and relatively high investment per household.

According to embodiments of the present application, an embodiment of a method for determining a sewage treatment mode is provided. It should be noted that the steps shown in the flowcharts of the accompanying drawings can be executed in a computer system that executes a set of computer-executable instructions. Moreover, although a logical order is shown in the flowcharts, in some cases, the steps shown or described may be executed in an order different from that herein.

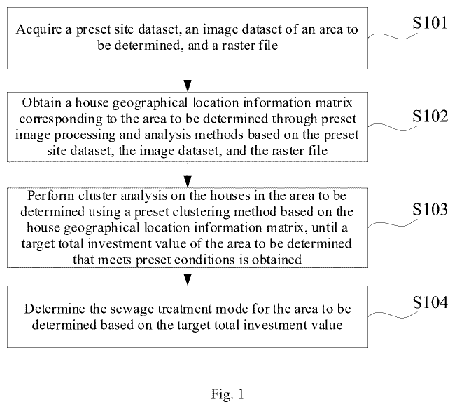

In this embodiment, a method for determining a sewage treatment mode is provided. FIG. 1 is a flowchart of a method for determining a sewage treatment mode according to an embodiment of the present application. As shown in FIG. 1, the process includes the following steps: step S101, acquiring a preset site dataset, an image dataset of an area to be determined, and a raster file.

The area to be determined can be a natural village or an administrative village.

Specifically, the image dataset includes a plurality of aerial images of the area to be determined, wherein the resolution of the aerial images is above 0.3 m, and the output format is a jpg or tif raster image.

In an example, the aerial image is stored in a jpg format and is denoted as LH_1.jpg.

Further, the raster file refers to a graphic file obtained by aerial photography of an area to be determined, and the raster file describes in the form of pixels or points and can be independently used for drawing or display.

Furthermore, the preset site dataset may include site packages such as ArcPy, OSGeo, and itertools.

Step S102: obtaining a house geographical location information matrix corresponding to the area to be determined through preset image processing and analysis methods based on the preset site dataset, the image dataset, and the raster file.

Specifically, the image dataset is processed by combining with the preset site dataset and the raster file and using the preset image processing and analysis methods, to obtain the geographical location information of each house in the area to be determined, and form a house geographical location information matrix corresponding to the area to be determined.

Step S103: performing cluster analysis on the houses in the area to be determined using a preset clustering method based on the house geographical location information matrix, until a target total investment value of the area to be determined that meets preset conditions is obtained.

Specifically, based on the house geographical location information matrix, by performing iterative cluster analysis on the houses in the area to be determined, the target total investment value of the area to be determined that ultimately meets the preset conditions can be calculated.

In the method for determining a sewage treatment mode provided in this embodiment, the house geographical location information matrix corresponding to the area to be determined can be determined by processing the image dataset and the site dataset of the area to be determined. Further, through iterative cluster analysis on the houses in the area to be determined using this house geographical location information matrix, the target total investment value of the area to be determined can be determined. Then, the sewage treatment mode of the area to be determined can be determined according to this target total investment value, with no need of performing a large number of on-site surveys and investigations based on subjective experience. Therefore, by implementing the present application, a final sewage treatment mode is determined by combining a preset clustering method based on image processing and analysis. The sewage treatment mode can be determined based on an objective scale, thereby reducing the time for determining the sewage treatment mode and improving the accuracy of determining the sewage treatment mode.

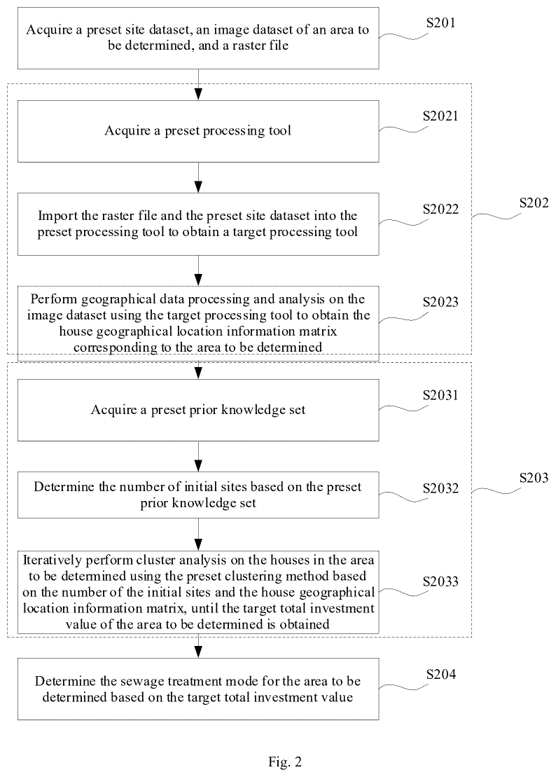

This embodiment provides a method for determining a sewage treatment mode. FIG. 2 is a flowchart of the method for determining a sewage treatment mode according to an embodiment of the present application. As shown in FIG. 2, the process includes the following steps:

Step S201: acquiring a preset site dataset, an image dataset of an area to be determined, and a raster file. For details, please refer to step S101 of the embodiment shown in FIG. 1, and the details will not be repeated herein.

Step S202: obtaining a house geographical location information matrix corresponding to the area to be determined through preset image processing and analysis methods based on the preset site dataset, the image dataset, and the raster file.

Specifically, the above step S202 includes:

Step S2021: acquiring a preset processing tool.

The preset processing tool can be Python software, etc.

Step S2022: importing the raster file and the preset site dataset into the preset processing tool to obtain a target processing tool.

Specifically, the acquired raster file and the preset site dataset are imported into the preset processing tool to obtain a target processing tool integrating the raster file and the preset site dataset.

Step S2023: performing geographical data processing and analysis on the image dataset using the target processing tool to obtain the house geographical location information matrix corresponding to the area to be determined.

Specifically, geographical data processing and analysis is performed on the image dataset by using a target processing tool that integrates raster files and the preset site dataset, to obtain the geographical location information of each house in the area to be determined, and form a house geographical location information matrix corresponding to the area to be determined.

Taking the preset processing tool being Python software as an example, the above geographical data processing and analysis process is described below.

Specifically, a GDAL library in an OSGeo module in Python software is used to read the raster image. RasterXSize and RasterYSize instructions are used to read the number of horizontal and vertical pixels of the raster data respectively. RasterCount is used to read the number of bands of the raster data. GetProjection instructions are used to acquire the coordinate information of the raster data, and an enumerate function is used to sort the points in an ascending order of longitude, and output a 3×38 data matrix A1, that is, the house geographical location information matrix.

A first column of the matrix represents the point number, a second column represents the point longitude, and a third column represents the point latitude.

Step S203: iteratively performing cluster analysis on houses in the area to be determined using a preset clustering method based on the house geographical location information matrix until a target total investment value of the area to be determined that meets preset conditions is obtained.

Specifically, the above step S203 includes:

Step S2031: acquiring a preset prior knowledge set.

Specifically, the preset prior knowledge set includes a plurality of pieces of prior knowledge, namely, expert experience.

Step S2032: determining the number of initial sites based on the preset prior knowledge set.

Specifically, the number of initial sites for centralized treatment, that is, the number of initial sites, can be determined according to the preset prior knowledge set.

Step S2033: iteratively performing cluster analysis on the houses in the area to be determined using the preset clustering method based on the number of the initial sites and the house geographical location information matrix, until the target total investment value of the area to be determined is obtained.

Specifically, an iterative cluster analysis is performed on the houses in the area to be determined by using the number of initial sites, and in the iterative cluster analysis process, the target total investment value of the area to be determined can be calculated in combination with the house geographical location information matrix.

In some optional embodiments, the above step S2033 includes:

Step a1: performing cluster analysis on the houses in the area to be determined using a preset clustering method based on the number of the initial sites, to obtain the number of first target sites and a site geographical location information matrix.

Step a2: processing through a preset analysis method and a preset calculation method based on the house geographical location information matrix and the site geographical location information matrix, to obtain a total investment value of the area to be determined under the number of the first target sites.

Step a3: judging whether the number of the first target sites meets the preset conditions.

Step a4: increasing the number of the first target sites when the number of the first target sites does not meet the preset conditions, and based on the increased total investment value of the corresponding area to be determined, repeating the step of performing cluster analysis on the houses in the area to be determined using a preset clustering method to obtain the number of first target sites and a site geographical location information matrix and repeating the step of processing through a preset analysis method and a preset calculation method based on the house geographical location information matrix and the site geographical location information matrix to obtain the total investment value of the area to be determined under the number of the first target sites, until the increased number of the first target sites meets the preset conditions, to obtain the total investment value of the area to be determined corresponding to each increased number of the first target sites.

Step a5: determining the target total investment value of the area to be determined based on each of the total investment values.

Step a6: when the number of the first target sites meets the preset conditions, taking the total investment value of the area to be determined corresponding to the number of the first target sites as the target total investment value of the area to be determined.

First, based on the number of initial sites, cluster analysis is performed on the houses in the area to be determined by using the k-means clustering method, to determine the number of optimal sites in the area to be determined, i.e., the number of the first target sites.

Further, the site geographical location information matrix corresponding to the area to be determined can be obtained according to the number of the first target sites and in combination with the preset clustering method.

Secondly, the total investment value of the area to be determined under the number of the first target sites can be calculated through the site geographical location information and house geographical location information included in the site geographical location information matrix and the house geographical location information matrix.

Finally, whether the number of the first target sites is greater than the number of the houses divided by five, that is, whether the preset conditions are met, is judged. If the number of the first target sites is greater than the number of houses divided by five, that is, if the preset conditions are met, the total investment value of the area to be determined under the number of the first target sites is taken as the final target total investment value of the area to be determined.

Further, if the number of the first target sites is less than the number of houses divided by five, that is, if the preset conditions are not met, 1 is added to the number of the first target sites and the operations from step a1 to step a2 are repeated, until the number of the first target sites meets the preset conditions, and the total investment values of the area to be determined corresponding to the value obtained when 1 is added to the number of the first target sites during the above repeated process are output. Then, the total investment values of the area to be determined obtained each time are compared, and the smallest total investment value among the total investment values is taken as the final target total investment value of the area to be determined.

In one example, the number of initial sites is 3. Through the above iterative process, it can be obtained that the preset conditions are met when the number of sites increases to 8. At this time, by comparing the total investment values corresponding to each number of sites from 3 to 8, it can be found that the total investment value is the smallest when the number of sites is 3. The smallest total investment value is 462,100 CNY, and the investment per household is 12,200 CNY. Moreover, the geographical location information of each site is (32.3494570° N, 118.7809709° E), (32.3481911° N, 32.3497620°N, 118.7837647°E), (32.3497620°N, 118.7848471° E).

In some optional embodiments, the above step a1 includes:

Step a11: performing cluster analysis on the houses in the area to be determined using a preset clustering method based on the number of the initial sites to obtain the number of first target sites that satisfy the conditions.

Step a12: clustering the area to be determined based on the number of the first target sites to obtain a plurality of initial sub-areas to be determined corresponding to the area to be determined.

Step a13: determining the initial site geographical location information matrix corresponding to the area to be determined through a preset screening and processing method based on a plurality of initial sub-areas to be determined.

Specifically, based on the number of initial sites, the k-means clustering method is used to iteratively divide the house clusters automatically until the locations of the cluster centers are stable, and the number of the corresponding first target sites is obtained.

When automatic iterative division is performed using the k-means clustering method, the Euclidean distance formula shown in the following equation (1) is used to calculate the clustering distance d:

$$d = \sqrt{{( {x}_{i} - {x}_{site} )}^{2} + {( {y}_{i} - {y}_{site} )}^{2}} \qquad ( 1 )$$

Further, to stabilize the location of the clustering center (xᵢ, yᵢ), the following conditions need to be met: the clustering center is located within a grid range of green spaces and farmlands, and the area of the central point is greater than 10 m².

Further, if the location of the clustering center does not meet the above conditions, the clustering center shall be removed and the iterative calculation shall be repeated until the above conditions are met.

Further, the area to be determined is clustered according to the determined number of the first target sites, and the area to be determined can be divided into a plurality of initial sub-areas to be determined.

Further, the initial site geographical location information matrix corresponding to the area to be determined can be obtained by presetting a screening and processing method.

In an example, when the number of the initial sites is 3, through iteration, the house points in the area are finally divided into three clusters: upper left, upper right, and lower right. Further, through screening and calculation, the site geographical location information matrix A2 is output, as shown in the following equation (2):

$$[ \begin{matrix}9 & 118.7809709 & 32.349457 \\ 20 & 118.7837647 & 32.3481911 \\ 9 & 118.7848471 & 32.349762\end{matrix} ] \qquad ( 2 )$$

The settlements are output in an ascending order of longitude. In the matrix, the first column represents the number of households within a cluster; the second column represents the longitude of the sites for centralized treatment of the cluster, with an east longitude being positive and a west longitude being negative; the third column represents the latitude of the sites, with a north latitude being positive and a south latitude being negative. That is, when the number of the sites is 3, the model divides the village into 3 settlements, containing 9 households, 20 households, and 9 households respectively. The longitude and latitude coordinates of the 3 sites are respectively (32.3494570°N, 118.7809709°E), (32.3481911°N, 118.7837647°E), (32.3497620° N, 118.7848471°E).

In some optional embodiments, the above step a2 includes:

Step a21: obtaining a pipeline length corresponding to the number of the first target sites through the Euclidean distance calculation formula based on the house geographical location information matrix and the site geographical location information matrix.

Step a22: processing through a preset analysis method and a preset calculation method based on the site geographical location information matrix and the pipeline length, to obtain the total investment value of the area to be determined under the number of the first target sites.

First, the pipeline length corresponding to the number of the first target sites is calculated using the Euclidean distance calculation formula shown in the following equation (3):

$$L = {Σ}_{i = 1}^{n} \sqrt{{( {x}_{i} - {x}_{site} )}^{2} + {( {y}_{i} - {y}_{site} )}^{2}} + {d}_{burial} n \qquad ( 3 )$$

In one example, using each house geographical location information matrix A1 and each site geographical location information matrix A2, the pipeline length under the optimal condition when the number of sites for centralized treatment is 3 is calculated. The pipeline burial depth is 0.5 m, the model output L satisfies a formula of L=787+0.5*38=806 m. The pipeline length per household in settlement 1 is L_{avg, 1}=18.39 m, the pipeline length per household in settlement 2 is L_{avg, 2}=20.06 m, the pipeline length per household in settlement 3 is L_{avg, 3}=20.75 m, and the pipeline length per household in the village is L_{avg}=21.21 m.

Secondly, technical and economic analysis is conducted.

Specifically, the size of the house can be obtained according to the site geographical location information matrix. Then, the corresponding water consumption of the settlement is calculated and treatment devices are selected by referring to the local standard matrix, and the local standard matrix includes the design scale of rural sewage and the corresponding treatment devices in each province.

The calculation formula for the total investment value of the village project, that is, the total investment value of the area to be determined, is shown in the following equation (4):

$$T = {Σ}_{i = 1}^{p} {aD}_{i} {L}_{i} + {Σ}_{m = 1}^{n} {Z}_{m} + {P}_{1} + {P}_{2} + {P}_{3} \qquad ( 4 )$$

Where: a represents the pipeline cost parameter; Dᵢ represents the pipe diameter; Lᵢ represents the pipeline length; P represents the number of pipelines in the area; Zₘ represents the cost of a centralized treatment facility; n represents the number of sites; P₁ represents the cost of ancillary structures, including inspection wells, inverted siphons, drop manholes, intercepting wells, etc.; P₂ represents the cost of a lift pump station; P₃ represents the project cost items, specifically including labor costs, machinery costs, water and electricity fees, communication fees, insurance fees and the like required for construction.

In an example, when the number of centralized treatment stations is 3, the number of household members is divided into 3, 5, and 7 in sequence. The per capita water consumption is calculated at 60 L/day, and the daily variation coefficient kd is equal to 2.2. The treated water volume (tons) of the facilities at each settlement site is respectively calculated and the results are rounded up. Then, using the above equation (4), the total investment value of the area to be determined can be calculated as 462,100 CNY, and the average investment per household is calculated as 12,200 CNY.

Step S204: determining the sewage treatment mode for the area to be determined based on the target total investment value. For details, please refer to step S104 in the embodiment shown in FIG. 1, and the details will not be repeated herein.

In the method for determining a sewage treatment mode provided in this embodiment, a preset processing tool with imported raster files and preset site datasets is utilized to perform geographical data processing and analysis on the image dataset, thereby improving the speed of image data processing. Further, based on the house geographical location information matrix, iterative cluster analysis is performed on the houses in the area to be determined in combination with a clustering method, thereby objectively determining the final number of sites. Further, the target total investment value of the area to be determined is determined based on the number of sites, making the target total investment value more objective. Therefore, by implementing the present application, the final sewage treatment mode is determined by combining the preset clustering method based on image processing and analysis, thereby determining the sewage treatment mode based on an objective scale, reducing the time for determining the sewage treatment mode, and improving the accuracy of determining the sewage treatment mode.

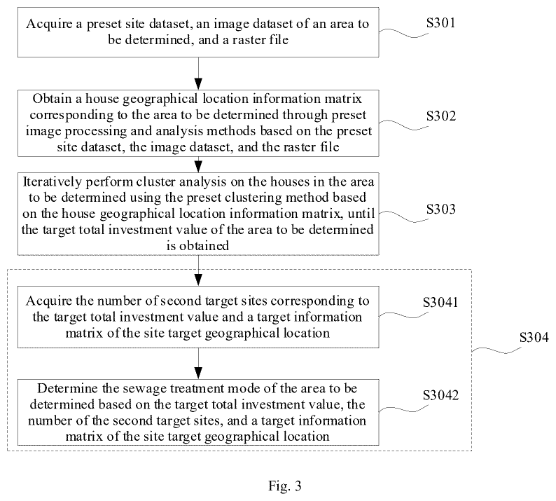

This embodiment provides a method for determining a sewage treatment mode. FIG. 3 is a flowchart of a method for determining the sewage treatment mode according to an embodiment of the present application. As shown in FIG. 3, the process includes the following steps:

Step S301: acquiring a preset site dataset, an image dataset of an area to be determined, and a raster file. For details, please refer to Step S101 of the embodiment shown in FIG. 1, and the details will not be repeated herein.

Step S302: obtaining a house geographical location information matrix corresponding to the area to be determined through preset image processing and analysis methods based on the preset site dataset, the image dataset, and the raster file. For details, please refer to step S202 of the embodiment shown in FIG. 2, and the details will not be repeated herein.

Step S303: iteratively performing cluster analysis on the houses in the area to be determined using the preset clustering method based on the house geographical location information matrix, until the target total investment value of the area to be determined is obtained. For details, please refer to step S203 of the embodiment shown in FIG. 2, and the details will not be repeated herein.

Step S304: determining the sewage treatment mode for the area to be determined based on the target total investment value.

Specifically, the above step S304 includes: step S3041, acquiring the number of second target sites corresponding to the target total investment value and a target information matrix of the site target geographical location.

Specifically, according to the description in step S2033, the target total investment value is the total investment value corresponding to the number of sites that meet the preset conditions. Therefore, the finally determined number of sites for centralized treatment, i.e., the number of the second target sites, can be determined according to the target total investment value.

Further, the target information matrix of the site target geographical location corresponding to the number of the second target sites can also be obtained.

Step S3042: determining the sewage treatment mode of the area to be determined based on the target total investment value, the number of the second target sites, and a target information matrix of the site target geographical location.

Specifically, the number and locations of sewage treatment sites can be determined by using the number of the second target sites and the target information matrix of the site target geographical locations. Further, the corresponding sewage treatment mode can be determined in combination with the total investment value of sewage treatment.

In the method for determining the sewage treatment mode provided in this embodiment, the area to be determined is processed according to the finally determined number of the second target sites, and the finally determined target information matrix of the site target geographical locations in the area to be determined can be obtained. Then, the sewage treatment mode of the area to be determined can be objectively determined in combination with the target total investment value, thereby reducing the time for determining the sewage treatment mode and improving the accuracy of determining the sewage treatment mode.

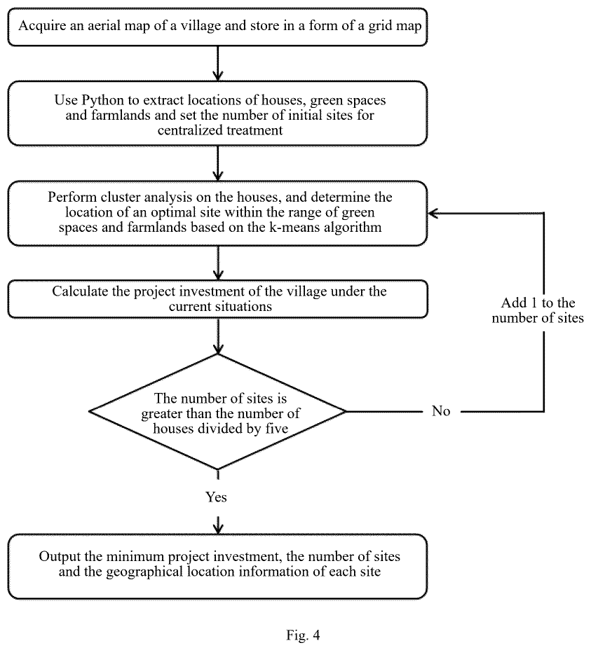

In an example, as shown in FIG. 4, a method for optimizing and determining the degree of decentralization and concentration in a rural sewage treatment mode is provided. Further, based on FIG. 4, specific implementation steps of this method are provided:

Step 1): acquiring aerial maps based on natural villages or administrative villages.

Step 2): using Python software to import site packages such as ArcPy, OSGeo, and itertools, as well as the raster files obtained from aerial photography, perform geographical data processing and analysis on the images, extract raster information of houses, farmlands, and green spaces, and set the number of the initial sites for centralized treatment based on prior knowledge.

Step 3): performing statistical analysis using the k-means clustering method, to iteratively divide the house clusters automatically until the locations of the cluster centers are stable, and output the optimal central points that meet the construction requirements.

Step 4): calculating and outputting the total pipeline length and the pipeline length per household in the village according to classification of the clusters under this condition and the locations of the sites for centralized treatment.

Step 5): performing technical and economic analysis, selecting a treatment device according to the number of houses within the cluster, and calculating the project investment under this condition based on the distances from the houses within the cluster to the site and the device investment.

Step 6): judging whether the number of sites is greater than the number of houses divided by five, wherein if the judgment fails, increase the number of sites and return to step 3) for iteration; if the judgment passes, compare the project investments in all cases, and output the global minimum project investment, investment per household, the number of sites for centralized treatment, and the geographical location information of each site.

Step 1) specifically includes: the resolution of the aerial image is above 0.3 m, and the output format of the aerial image is a jpg or tif raster image;

Step 3) specifically includes: when the distance in the k-means algorithm is calculated, the Euclidean distance formula is used, as shown in the above equation (1);

Step 4) specifically includes: the pipeline distance is calculated using the Euclidean distance formula, and the calculation formula for the total length of the pipeline is as shown in the above equation (3);

Step 5) specifically includes: according to the number of houses within the cluster calculated in Step 3), the corresponding water consumption of the settlement is calculated and a treatment device is selected by referring to the local standard matrix, the local standard matrix includes the design scale of rural sewage and the corresponding treatment device in each province. The calculation formula for the total investment of the village project is as shown in the above equation (4).

In the method for optimizing and determining the degree of decentralization and concentration in the rural sewage treatment mode provided in this example, high-precision aerial images are used to quickly identify rural land types and extract raster information such as houses, farmlands, and green spaces in the area and store by category. Geographic information data is conducive to subsequent information customized display, retrieval, and accurate decision-making analysis, and can provide support and reference for regional management and macro-policies. Meanwhile, a software model is used to quickly screen the points with the lowest construction cost. The clustering calculation steps are clear and strict, with clear classification thresholds and attribute assignment rules, and stable and reliable calculation results. Furthermore, the programming language used is concise, with strong interactivity and operability. It is beneficial for non-professionals to quickly modify differential parameters according to specific situations. At the same time, the model is trained through deep learning based on existing engineering applications. The calculation conditions of the model highly conform to the actual engineering construction situation, and the calculation results are highly accurate and representative. Further, the calculation program is highly optimized and has a fast calculation speed, and can be used for rapid calculation of the number and locations of sites in large-scale rural sewage treatment projects, and the results can serve as a basis for engineering investment and construction.

Further, based on the method for optimizing and determining the degree of decentralization and centralization in the rural sewage treatment mode provided in the above example, a specific example is provided, and the following steps are included:

Step 1): acquiring a high-precision aerial map of a certain natural village, wherein the resolution of the aerial image is 0.3 m, and the aerial image is stored in a jpg format and is denoted as LH_1.jpg.

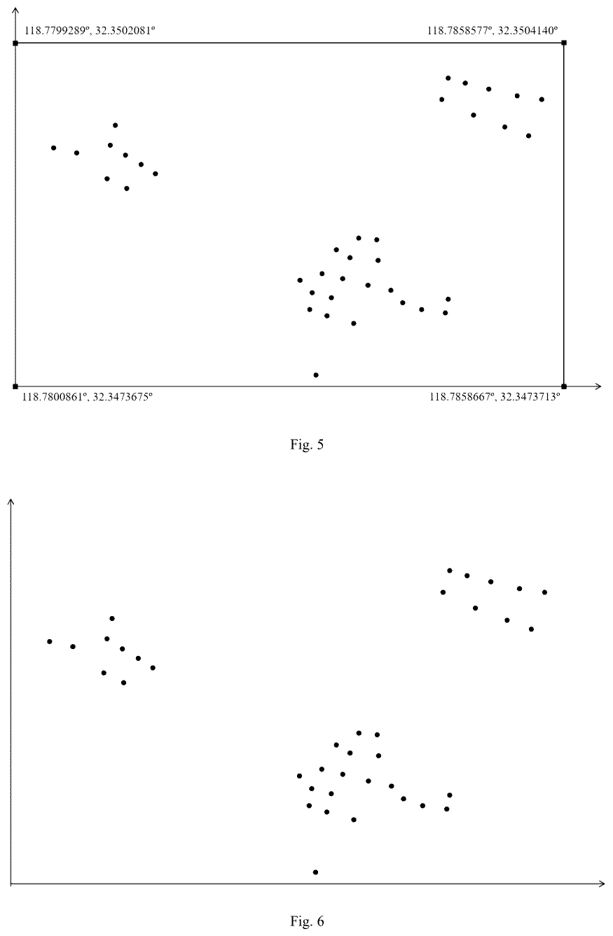

Step 2): using Python software to import site packages such as ArcPy, 0Sgeo, and itertools, calling LH_1, and identifying the raster data of houses, farmlands, and green spaces, to obtain the initial house point map with geographical location information as shown in FIG. 5 and the initial house point map without geographical location information as shown in FIG. 6. A GDAL library in an OSGeo module is used to read the raster image; RasterXSize and RasterYSize instructions are used to read the number of horizontal and vertical pixels of the raster data respectively; RasterCount is used to read the number of bands of the raster data. GetProjection instructions are used to acquire the coordinate information of the raster data, and an enumerate function is used to sort the points in an ascending order of longitude, to output a 3×38 data matrix A1. The first column of the matrix is the point number, the second column is the longitude of the point, and the third column is the latitude of the point. The raster information of houses, farmlands, and green spaces is extracted, and the number ZD of initial sites for centralized treatment is set to be equal to 3 based on prior knowledge.

Step 3): performing statistical analysis using the k-means clustering method, wherein when ZD is equal to 3, through iteration, the model finally divides the house points in this area into three clusters: upper left, upper right, and lower right. Through further screening and calculation, the model outputs the site geographical location information matrix A2 as shown in the above equation (2).

Step 4): calculating the pipeline distance using the above equation (3), wherein specifically, each house geographical location information matrix A1 and each site geographical location information matrix A2 are utilized to calculate the pipeline length under an optimal condition when the number of sites for centralized treatment is 3. The pipeline burial depth is 0.5 m, the model output L satisfies a formula of L=787+0.5*38=806 m. The pipeline length per household in settlement 1 is L_{avg, 1}=18.39 m, the pipeline length per household in settlement 2 is L_{avg, 2}=20.06 m, the pipeline length per household in settlement 3 is L_{avg, 3}=20.75 m, and the pipeline length per household in the village is L_{avg}=21.21 m.

Step 5): performing technical and economic analysis, wherein according to the identified size of the houses, the number of household members is divided into 3, 5, and 7 in sequence. The per capita water consumption is calculated at 60 L/day, and the daily variation coefficient kd is equal to 2.2. The treated water volume (tons) of the facilities at each settlement site is respectively calculated and the results are rounded up. Then, using the above equation (4), the total investment value of the area to be determined can be calculated as 462,100 CNY, and the average investment per household is calculated as 12,200 CNY.

Step 6): judging whether the condition is met, wherein at this time, if the number of sites is less than the number of houses divided by five, add 1 to the number of sites and return to re-operate Step 3) to Step 5); when the number of sites increases to 8, the judgment passes. The model compares the project investments in all cases. At this time, the output global minimum engineering investment is 462,100 CNY, the average investment per household is 12,200 CNY, the number of sites for centralized treatment is 3, and the geographical location information of each site is (32.3494570°N, 118.7809709°E), (32.3481911°N, 118.7837647°E), (32.3497620°N, 118.7848471° E). Compared with the current average investment per household of 25,000 CNY in the rural sewage treatment project of this natural village, the total investment cost calculated by this method is greatly reduced.

This embodiment further provides an apparatus for determining a sewage treatment mode. This apparatus is configured to implement the above embodiments and preferred implementation manners, and the content that has been described will not be repeated herein. As used below, the term “module” can be a combination of software and/or hardware that implements a predetermined function. Although the apparatuses described in the following embodiments are preferably implemented in software, implementation in hardware or a combination of software and hardware is also possible and conceived.

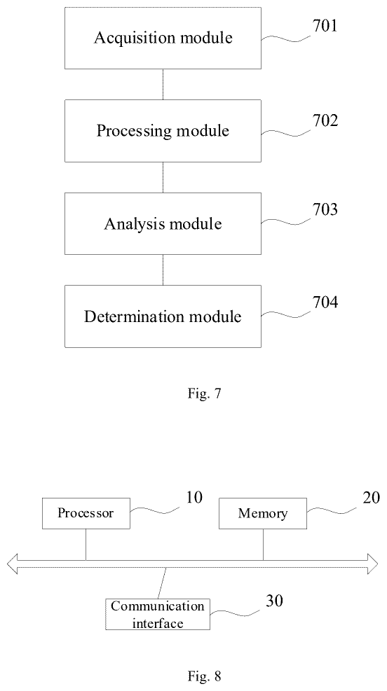

This embodiment provides an apparatus for determining a sewage treatment mode. As shown in FIG. 7, the apparatus includes:
an acquisition module 701 configured to acquire a preset site dataset, an image dataset of the area to be determined, and a raster file;
a processing module 702 configured to obtain a house geographical location information matrix corresponding to the area to be determined through preset image processing and analysis methods based on the preset site dataset, the image dataset, and the raster file;
an analysis module 703 configured to iteratively perform cluster analysis on the houses in the area to be determined using a preset clustering method based on the house geographical location information matrix, until a target total investment value of the area to be determined that meets preset conditions is obtained; and
a determination module 704 configured to determine the sewage treatment mode of the area to be determined based on the target total investment value.

In some optional embodiments, the processing module 702 includes:
a first acquisition submodule configured to acquire a preset processing tool;
an import submodule configured to import the raster file and the preset site dataset into the preset processing tool to obtain a target processing tool; and
a processing submodule configured to perform geographical data processing and analysis on the image dataset by using the target processing tool, to obtain the house geographical location information matrix corresponding to the area to be determined.

In some optional embodiments, the analysis module 703 includes: a second acquisition submodule configured to acquire a preset prior knowledge set;
a first determination submodule configured to determine the number of initial sites based on the preset prior knowledge set; and
an analysis submodule configured to iteratively perform cluster analysis on the houses in the area to be determined by using the preset clustering method based on the number of the initial sites and the house geographical location information matrix until the target total investment value of the area to be determined is obtained.

In some optional embodiments, the analysis submodule includes: an analysis unit configured to perform cluster analysis on the houses in the area to be determined by using a preset clustering method based on the number of the initial sites, to obtain the number of first target sites and the site geographical location information matrix;
a processing unit configured to process through a preset analysis method and a preset calculation method based on the house geographical location information matrix and the site geographical location information matrix to obtain the total investment value of the area to be determined under the number of the first target sites;
a judgment unit configured to judge whether the number of the first target sites meets the preset conditions;
a repetition unit configured to increase the number of the first target sites when the number of the first target sites does not meet the preset conditions, and based on the increased total investment value of the corresponding area to be determined, repeat the step of performing cluster analysis on the houses in the area to be determined using the preset clustering method to obtain the number of the first target sites and the site geographical location information matrix and repeat the step of processing through a preset analysis method and a preset calculation method based on the house geographical location information matrix and the site geographical location information matrix to obtain the total investment value of the area to be determined under the number of the first target sites, until the increased number of the first target sites meets the preset conditions, to obtain the total investment value of the area to be determined corresponding to each increased number of the first target sites; and
a first determination unit configured to determine the target total investment value of the area to be determined based on each of the total investment values.

In some optional embodiments, the analysis submodule further includes:
a second determination unit configured to: when the number of the first target sites meets the preset conditions, take the total investment value of the area to be determined under the number of the first target sites as the target total investment value of the area to be determined.

In some optional embodiments, the analysis unit includes:
an analysis subunit configured to perform cluster analysis on the houses in the area to be determined by using a preset clustering method based on the number of initial sites, so as to obtain the number of the first target sites that meet the conditions;
a clustering subunit configured to cluster the area to be determined based on the number of the first target sites, to obtain a plurality of initial sub-areas to be determined corresponding to the area to be determined; and
a screening and processing subunit configured to determine the initial site geographical location information matrix corresponding to the area to be determined through a preset screening and processing method based on a plurality of initial sub-areas to be determined.

In some optional embodiments, the processing unit includes:
a calculation subunit configured to obtain a pipeline length corresponding to the number of the first target sites through the Euclidean distance calculation formula based on the house geographical location information matrix and the site geographical location information matrix; and
an analysis and calculation subunit configured to process through a preset analysis method and a preset calculation method based on the site geographical location information matrix and the pipeline length to obtain the total investment value of the area to be determined under the number of the first target sites.

In some optional embodiments, the determination module 704 includes:
a third acquisition submodule configured to acquire the number of second target sites corresponding to the target total investment value and a target information matrix of the site target geographical location; and
a second determination sub-module configured to determine the sewage treatment mode of the area to be determined based on the target total investment value, the number of the second target sites, and a target information matrix of the site target geographical location.

Further functional descriptions of the above modules and units are the same as those in the corresponding embodiments described above, and will not be repeated herein.

The apparatus for determining the sewage treatment mode in this embodiment is presented in the form of functional units. Herein, a unit refers to an ASIC (Application Specific Integrated Circuit) circuit, a processor and a memory that execute one or more software or fixed programs, and/or other devices that can provide the above functions.

The embodiments of the present application also provide a computer device equipped with the apparatus for determining the sewage treatment mode shown in FIG. 7 above.

Please refer to FIG. 8. FIG. 8 is a structural schematic diagram of a computer device provided in an optional embodiment of the present application. As shown in FIG. 8, the computer device includes: one or more processors 10, a memory 20, and interfaces for connecting various components, and the interfaces include high-speed interfaces and low-speed interfaces. The components are communicatively connected with each other using different buses and can be mounted on a common motherboard or can be mounted in other ways as needed. The processor can process instructions executed within the computer device, including instructions stored in the memory or on the memory for displaying graphical information of the GUI on an external input/output apparatus (such as a display device coupled to the interface). In some optional embodiments, a plurality of processors and/or a plurality of buses can be used together with a plurality of memories if necessary. Similarly, a plurality of computer devices can be connected, and each device provides some necessary operations (for example, as a server array, a group of blade servers, or a multi-processor system). In FIG. 8, one processor 10 is taken as an example.

The processor 10 can be a central processing unit, a network processor, or a combination thereof. The processor 10 may further include a hardware chip. The above hardware chip can be an application-specific integrated circuit, a programmable logic device, or a combination thereof. The above programmable logic device can be a complex programmable logic device, a field-programmable gate array, a generic array logic, or any combination thereof.

The memory 20 stores instructions executable by at least one processor 10, such that the at least one processor 10 executes the method shown in the above embodiments.

The memory 20 may include a program storage area and a data storage area, wherein the program storage area can store an operating system and application programs required for at least one function; and the data storage area can store data created according to the use of the computer device, etc. In addition, the memory 20 may include a high-speed random-access memory and may also include non-transitory memories, such as at least one magnetic disk storage device, a flash memory device, or other non-transitory solid-state storage devices. In some optional embodiments, the memory 20 may optionally include memories remotely located relative to the processor 10, and these remote memories may be connected to the computer device via a network. Examples of the above network include, but are not limited to, the Internet, an intranet, a local area network, a mobile communication network, and combinations thereof.

The memory 20 may include a volatile memory, such as a random-access memory; the memory may also include a non-volatile memory, such as a flash memory, a hard disk or a solid-state drive; and the memory 20 may also include a combination of the above types of memories.

The computer device further includes a communication interface 30 configured to enable the computer device to communicate with other devices or communication networks.

The embodiments of the present application also provide a computer-readable storage medium. The methods according to the embodiments of the present application may be implemented in hardware or firmware, or as a computer code that can be recorded on a storage medium, downloaded over a network, stored on a remote storage medium or a non-transitory machine-readable storage medium, and stored on a local storage medium. Therefore, the method described herein can be processed by such software stored on a storage medium using a general-purpose computer, a dedicated processor, or programmable or dedicated hardware. The storage medium can be a magnetic disk, an optical disk, a read-only memory, a random-access memory, a flash memory, a hard disk, a solid-state drive, etc. Further, the storage medium can also include a combination of the above types of memories. It can be understood that a computer, a processor, a microprocessor controller, or programmable hardware includes a storage component that can store or receive software or computer code. When the software or computer code is accessed and executed by the computer, the processor, or the hardware, the method shown in the above embodiments is implemented.

Although the embodiments of the present application are described in conjunction with the accompanying drawings, various modifications and variations can be made by those skilled in the art without departing from the spirit and scope of the present application, and such modifications and variations shall all fall within the scope defined by the appended claims.

1. A method for determining a sewage treatment mode, comprising:
acquiring a preset site dataset, an image dataset of an area to be determined, and a raster file;
obtaining a house geographical location information matrix corresponding to the area to be determined through preset image processing and analysis methods based on the preset site dataset, the image dataset, and the raster file;
iteratively performing cluster analysis on houses in the area to be determined using a preset clustering method based on the house geographical location information matrix, until a target total investment value of the area to be determined that meets preset conditions is obtained; and
determining the sewage treatment mode of the area to be determined based on the target total investment value.

2. The method according to claim 1, wherein the step of obtaining a house geographical location information matrix corresponding to the area to be determined through preset image processing and analysis methods based on the preset site dataset, the image dataset, and the raster file comprises:
acquiring a preset processing tool;
importing the raster file and the preset site dataset into the preset processing tool to obtain a target processing tool; and
performing geographical data processing and analysis on the image dataset using the target processing tool to obtain the house geographical location information matrix corresponding to the area to be determined.

3. The method according to claim 1, wherein the step of iteratively performing cluster analysis on houses in the area to be determined using a preset clustering method based on the house geographical location information matrix until a target total investment value of the area to be determined that meets preset conditions is obtained comprises:
acquiring a preset prior knowledge set;
determining the number of initial sites based on the preset prior knowledge set; and
iteratively performing cluster analysis on the houses in the area to be determined using the preset clustering method based on the number of the initial sites and the house geographical location information matrix, until the target total investment value of the area to be determined is obtained.

4. The method according to claim 3, wherein the step of iteratively performing cluster analysis on the houses in the area to be determined using the preset clustering method based on the number of the initial sites and the house geographical location information matrix until the target total investment value of the area to be determined is obtained comprises:
performing cluster analysis on the houses in the area to be determined using a preset clustering method based on the number of the initial sites, to obtain the number of first target sites and a site geographical location information matrix;
processing through a preset analysis method and a preset calculation method based on the house geographical location information matrix and the site geographical location information matrix, to obtain a total investment value of the area to be determined under the number of the first target sites;
judging whether the number of the first target sites meets the preset conditions;
increasing the number of the first target sites when the number of the first target sites does not meet the preset conditions, and based on the increased total investment value of the corresponding area to be determined, repeating the step of performing cluster analysis on the houses in the area to be determined using a preset clustering method to obtain the number of first target sites and a site geographical location information matrix and repeating the step of processing through a preset analysis method and a preset calculation method based on the house geographical location information matrix and the site geographical location information matrix to obtain the total investment value of the area to be determined under the number of the first target sites, until the increased number of the first target sites meets the preset conditions, to obtain the total investment value of the area to be determined corresponding to each increased number of the first target sites; and
determining the target total investment value of the area to be determined based on each of the total investment values.

5. The method according to claim 4, further comprising:
when the number of the first target sites meets the preset conditions, taking the total investment value of the area to be determined under the number of the first target sites as the target total investment value of the area to be determined.

6. The method according to claim 4, wherein the step of performing cluster analysis on the houses in the area to be determined using a preset clustering method based on the number of the initial sites to obtain the number of first target sites and a site geographical location information matrix comprises:
performing cluster analysis on the houses in the area to be determined using a preset clustering method based on the number of the initial sites, to obtain the number of the first target sites that meet the conditions;
clustering the area to be determined based on the number of the first target sites, to obtain a plurality of initial sub-areas to be determined corresponding to the area to be determined; and
determining the initial site geographical location information matrix corresponding to the area to be determined through a preset screening processing method based on the plurality of initial sub-areas to be determined.

7. The method according to claim 4, wherein the step of processing through a preset analysis method and a preset calculation method based on the house geographical location information matrix and the site geographical location information matrix to obtain the total investment value of the area to be determined under the number of the first target sites comprises:
obtaining a pipeline length corresponding to the number of the first target sites through the Euclidean distance calculation formula based on the house geographical location information matrix and the site geographical location information matrix; and
processing through a preset analysis method and a preset calculation method based on the site geographical location information matrix and the pipeline length, to obtain the total investment value of the area to be determined under the number of the first target sites.

8. The method according to claim 1, wherein the step of determining the sewage treatment mode of the area to be determined based on the target total investment value comprises:
acquiring the number of second target sites corresponding to the target total investment value and a target information matrix of the site target geographical location; and
determining the sewage treatment mode of the area to be determined based on the target total investment value, the number of the second target sites, and a target information matrix of the site target geographical location.

9. An apparatus for determining a sewage treatment mode, comprising:
an acquisition module configured to acquire a preset site dataset, an image dataset of the area to be determined, and a raster file;
a processing module configured to obtain a house geographical location information matrix corresponding to the area to be determined through preset image processing and analysis methods based on the preset site dataset, the image dataset, and the raster file;
an analysis module configured to iteratively perform cluster analysis on the houses in the area to be determined using a preset clustering method based on the house geographical location information matrix, until a target total investment value of the area to be determined that meets preset conditions is obtained; and
a determination module configured to determine the sewage treatment mode of the area to be determined based on the target total investment value.

10. The apparatus according to claim 9, wherein the processing module comprises:
a first acquisition submodule configured to acquire a preset processing tool;
an import submodule configured to import the raster file and the preset site dataset into the preset processing tool to obtain a target processing tool; and
a processing submodule configured to perform geographical data processing and analysis on the image dataset by using the target processing tool, to obtain the house geographical location information matrix corresponding to the area to be determined.

11. The apparatus according to claim 9, wherein the analysis module comprises:
a second acquisition submodule configured to acquire a preset prior knowledge set;
a first determination submodule configured to determine the number of initial sites based on the preset prior knowledge set; and
an analysis submodule configured to iteratively perform cluster analysis on the houses in the area to be determined by using the preset clustering method based on the number of the initial sites and the house geographical location information matrix until the target total investment value of the area to be determined is obtained.

12. The apparatus according to claim 11, wherein the analysis submodule comprises:
an analysis unit configured to perform cluster analysis on the houses in the area to be determined by using a preset clustering method based on the number of the initial sites, to obtain the number of first target sites and the site geographical location information matrix;
a processing unit configured to process through a preset analysis method and a preset calculation method based on the house geographical location information matrix and the site geographical location information matrix to obtain the total investment value of the area to be determined under the number of the first target sites;
a judgment unit configured to judge whether the number of the first target sites meets the preset conditions;
a repetition unit configured to increase the number of the first target sites when the number of the first target sites does not meet the preset conditions, and based on the increased total investment value of the corresponding area to be determined, repeat the step of performing cluster analysis on the houses in the area to be determined using the preset clustering method to obtain the number of the first target sites and the site geographical location information matrix and repeat the step of processing through a preset analysis method and a preset calculation method based on the house geographical location information matrix and the site geographical location information matrix to obtain the total investment value of the area to be determined under the number of the first target sites, until the increased number of the first target sites meets the preset conditions, to obtain the total investment value of the area to be determined corresponding to each increased number of the first target sites; and
a first determination unit configured to determine the target total investment value of the area to be determined based on each of the total investment values.

13. The apparatus according to claim 12, wherein the analysis submodule further comprises:
a second determination unit configured to: when the number of the first target sites meets the preset conditions, take the total investment value of the area to be determined under the number of the first target sites as the target total investment value of the area to be determined.

14. A computer device, comprising a memory and a processor, wherein the memory and the processor are communicatively connected with each other, computer instructions are stored in the memory, and the processor is configured to execute the method for determining the sewage treatment mode according to claim 1 by executing the computer instructions.

15. A computer-readable storage medium, wherein the computer-readable storage medium has computer instructions stored therein, and the computer instructions are configured to enable a computer to execute the method for determining the sewage treatment mode according to claim 1.
